(19) United States
(12) Patent Application Publication
(10) Pub. No.: US 2008/0219576 A1
(43) Pub. Date: Sep. 11, 2008

(54) Method and apparatus for encoding/decoding image

(75) Inventors: Jae-woo Jung, Seoul (KR); Dae-sung Cho, Seoul (KR); Attila Licsar, Veszprem (HU); Gergely Csaszar, Veszprem (HU); Laszlo Czuni, Veszprem (HU)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/984,116

(22) Filed: Nov. 13, 2007

(30) Foreign Application Priority Data
Mar. 7, 2007 (KR) 10-2007-0022575

(51) Int. Cl. G06K 9/36

(52) U.S. Cl. 382/238

(57) ABSTRACT

Provided are a method and apparatus for encoding/decoding an image. The method of encoding an image includes predicting pixel values in a first pixel group from among pixel groups of a block of a current image, using pixel values in a second pixel group of the block, and encoding the current image using the predicted pixel values. Accordingly, prediction efficiency can be increased by performing intra prediction using pixels in a current block.

### CROSS-REFERENCE TO RELATED PATENT APPLICATION

This application claims the benefit of Korean Patent Application No. 10-2007-0022575, filed on Mar. 7, 2007, in the Korean Intellectual Property Office, the disclosure of which is incorporated herein in its entirety by reference.

### BACKGROUND OF THE INVENTION

1. Field of the Invention

The present invention relates to encoding and decoding an image, and more particularly, to a method and apparatus for encoding/decoding an H.264 video image.

2. Description of the Related Art

Conventional methods of compressing an image, such as MPEG-1, MPEG-2, and MPEG-4H.264/MPEG-4 advanced video coding (AVC) encode an image by dividing it into macro blocks and encoding each macro block using inter prediction and intra prediction. The macro blocks are encoded after selecting a suitable encoding mode by considering the data size of the encoded macro block and distortion of the original macro block.

In intra prediction, a macro block is encoded using pixel values of pixels spatially adjacent to the current block that is to be encoded. First, a prediction value of the current block that is to be encoded is calculated using pixel values of pixels in a neighboring block adjacent to the current block. Then, the difference between the prediction value and a pixel value of the original current block is encoded. Intra prediction is usually used on luminance components or chrominance components. The intra prediction mode in luminance components can be a 4×4 intra prediction mode, an 8×8 intra prediction mode, or a 16×16 intra prediction mode.

FIG. 1 illustrates a conventional 16×16 intra prediction mode and FIG. 2 illustrates a conventional 4×4 intra prediction mode.

Referring to FIG. 1, the 16×16 intra prediction mode includes a total of four modes: a vertical mode, a horizontal mode, a direct current (DC) mode, and a plane mode. Referring to FIG. 2, the 4×4 intra prediction mode includes a total of nine modes: a vertical mode, a horizontal mode, a DC mode, a diagonal down-left mode, a diagonal down-right mode, a vertical right mode, a vertical left mode, a horizontal-up mode, and a horizontal-down mode.

The current block is encoded according to one of the 16×16 intra prediction modes or the 4×4 intra prediction modes. For example, operations of prediction encoding a 4×4 current block using the vertical mode of FIG. 2 will be described. First, pixel values of pixels A through D, adjacent to the upper part of the 4×4 current block, are predicted as pixel values of the 4×4 current block. That is, the pixel value of pixel A is predicted as four pixel values included in the first column of the 4×4 current block, the pixel value of pixel B is predicted as four pixel values included in the second column of the 4×4 current block, the pixel value of pixel C is predicted as four pixel values included in the third column of the 4×4 current block, and the pixel value of pixel D is predicted as four pixel values included in the fourth column of the 4×4 current block. Next, the difference between the prediction values of the 4×4 current block predicted using pixels A through D and actual values of pixels included in the original 4×4 current block is obtained, and a bit-stream of the 4×4 current block is generated by encoding the difference.

As described above, the remaining 8 modes of the 4×4 intra prediction modes and the 4 modes of the 16×16 intra prediction modes can predict a pixel value of the current block using pixels in a block adjacent to the current block.

However, using the conventional 16×16 intra prediction mode and 4×4 intra prediction mode, pixels along a vertical direction, a horizontal direction, or a diagonal direction of the current block are predicted using one pixel value as illustrated in FIGS. 1 and 2. For example, when the current block is predicted according to the vertical mode of FIG. 1, all pixel values along an arrow are predicted using one pixel value adjacent to the current block.

Accordingly, when an image in the current block is not the same image as an adjacent pixel along a vertical direction, a horizontal direction, or a diagonal direction, the pixel values in the current block cannot be accurately predicted. Using the 16×16 intra prediction mode, the compression rate of image data is low due to failure in predicting the pixel values of the current block.

### SUMMARY OF THE INVENTION

The present invention provides a method and apparatus for encoding/decoding an image which can increase the compression rate of encoding image data by enabling accurate prediction using a new prediction mode in addition to a conventional intra prediction mode.

The present invention also provides a computer readable recording medium having recorded thereon a program for executing the method described above.

According to an aspect of the present invention, there is provided claim 1

According to another aspect of the present invention, there is provided a computer readable recording medium having recorded thereon a program for executing the method described above.

According to another aspect of the present invention, there is provided claim 10

According to another aspect of the present invention, there is provided claim 11

According to another aspect of the present invention, there is provided a computer readable recording medium having recorded thereon a program for executing the method described above.

According to another aspect of the present invention, there is provided claim 17

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional 16×16 intra prediction mode;

FIG. 2 illustrates a conventional 4×4 intra prediction mode;

FIG. 3 is a block diagram of an apparatus for encoding an image according to an embodiment of the present invention;

FIG. 4 is a block diagram of an encoder and a reconstructor according to an embodiment of the present invention;

FIGS. 5A through 5C are diagrams for describing an example of calculating a prediction error via intra prediction in a row mode;

FIG. 5D is a diagram for describing an example of calculating a prediction error via intra prediction in a column mode;

FIG. 6 is a flowchart of a method of encoding an image according to an embodiment of the present invention;

FIG. 7 is a flowchart illustrating a method of encoding an image according to another embodiment of the present invention;

FIG. 8 is a graph of peak signal to noise ratios (PSNRs) of a convention 4×4 intra prediction mode and a conventional intra prediction mode when a row mode and a column mode are used instead of the 5^{th} and 7^{th} modes of the conventional intra prediction mode;

FIG. 9 is a graph of PSNR of various methods of encoding an image in an intra prediction mode according to the present invention and a conventional 16×16 intra prediction mode;

FIG. 10 is a block diagram of an apparatus for decoding an image according to an embodiment of the present invention;

FIG. 11 is a block diagram of a decoder according to an embodiment of the present invention; and

FIG. 12 is a flowchart illustrating a method of decoding an image according to an embodiment of the present invention.

### DETAILED DESCRIPTION OF THE INVENTION

The present invention will now be described more fully with reference to the accompanying drawings, in which exemplary embodiments of the invention are shown.

The present application suggests a new intra prediction mode, besides the 4 conventional 16×16 intra prediction modes and the 9 conventional 4×4 intra prediction modes. According to conventional intra prediction modes, a current block that is to be encoded is intra predicted using pixel values of pixels in another block adjacent to the current block. However, the new intra prediction mode according to the present invention predicts the current block using pixel values of pixels in the current block.

The new intra prediction mode includes a row mode and a column mode, and can be applied in the conventional 16×16 intra prediction modes and 4×4 intra prediction modes. In the row mode, pixels of the current block are intra predicted in row order. In other words, the first row is intra predicted, encoded, and reconstructed, and then the second row is intra predicted, encoded, and reconstructed using the reconstructed first row. Also in the column mode, pixels of the current block are intra predicted in column order. In other words, the first column is intra predicted, encoded, and reconstructed, and then the second column is intra predicted, encoded, and reconstructed using the reconstructed first column. Besides the row mode and the column mode, one of ordinary skill in the art can suggest other embodiments, such as a diagonal mode. Here, in the diagonal mode, pixels of the current block are intra predicted in diagonal down-left order or diagonal down-right order.

The row mode and the column mode of the present invention can be applied to the conventional 16×16 intra prediction modes and 4×4 intra prediction modes as an addition type, a substitution type, or an adaptive type.

In an addition type, the row mode and the column mode are added to the conventional intra prediction modes, giving 6 16×16 intra prediction modes and 11 4×4 intra prediction modes.

In a substitution type, the row mode or the column mode is used instead of a conventional intra prediction mode that is less frequently used. In this case, the row mode and the column mode are used instead of a vertical right mode and a vertical left mode, which have low usage frequency.

In an adaptive type, two of the conventional intra prediction modes that are used least are selected, using a device such as an edge detection filter, while encoding an image, and the row mode and the column mode are used instead of the two selected modes.

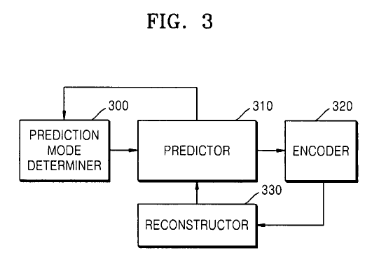

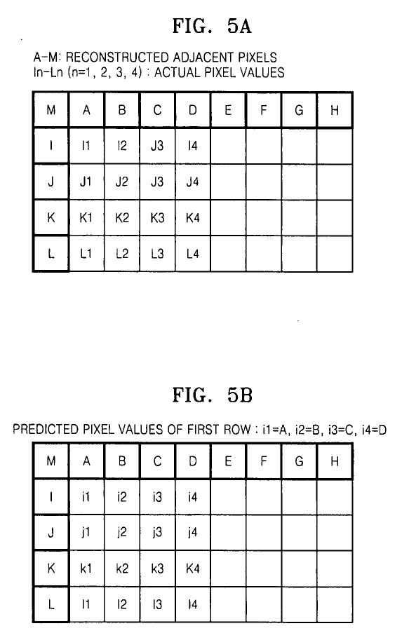

FIG. 3 is a block diagram of an apparatus for encoding an image according to an embodiment of the present invention, FIGS. 5A through 5C are diagrams for describing an example of calculating a prediction error via intra prediction in a row mode, and FIG. 5D is a diagram for describing an example of calculating a prediction error via intra prediction in a column mode.

Referring to FIG. 3, the apparatus includes a prediction mode determiner 300, a predictor 310, an encoder 320, and a reconstructor 330.

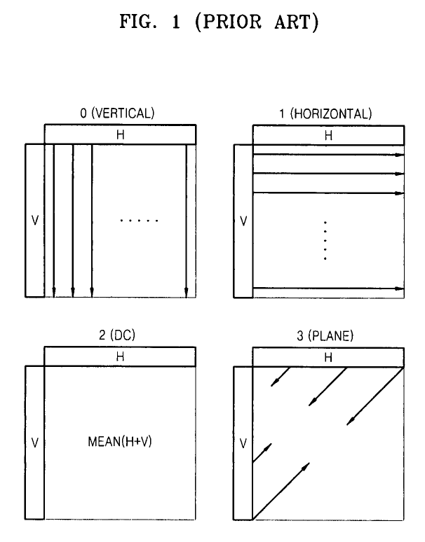

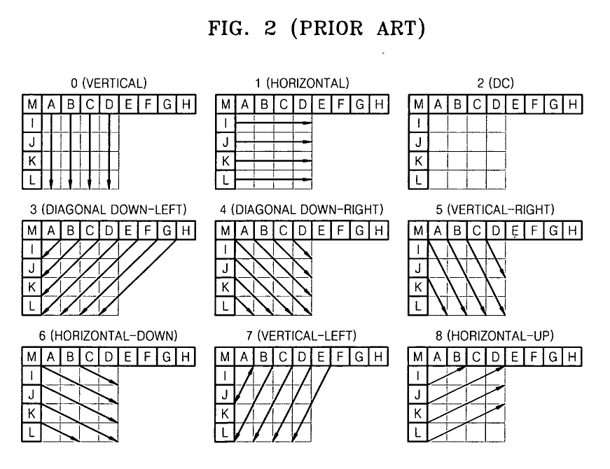

The predictor 310 performs intra prediction to find predicted values of pixels in a current block in a current picture. The predictor 310 according to the current embodiment of the present invention not only performs intra prediction in a 16×16 intra prediction mode or a 4×4 intra prediction mode as illustrated in FIGS. 1 and 2, but also performs intra prediction using pixel values in the current block.

The process of performing intra prediction using the pixel values in the current block will now be described in detail. When a current image is formed of a plurality of blocks and a block is formed of a plurality of pixel groups, the predictor 310 predicts pixel values in a first pixel group using pixel values in a second pixel group.

In the row prediction mode, the first pixel group is formed of pixels in a first row, and the second pixel group is formed of A, B, C, and D, which are pixels in the row above the first row, as illustrated in FIGS. 5A and 5B. In this case, the predictor 310 predicts the pixels in the first row respectively as A, B, C, and D, which are pixels in the row above the first row.

In the column prediction mode, the first pixel group is formed of pixels in a first column and the second pixel group is formed of I, J, K, and L, which are pixels in the column to the left of the first column, as illustrated in FIG. 5D. In this case, the predictor 310 predicts the pixels in the first column respectively as I, J, K, and L, which are pixels in the column to the left of the first column.

However, in the row prediction mode, when the first row is the top row of the current block, the pixel values in the first row are predicted using pixel values in the lowest row of the block above the current block. In the column prediction mode, when the first column is the leftmost column of the current block, the pixel values in the first column are predicted using pixel values in the rightmost column of the block to the left of the current block.

The prediction mode determiner 300 determines the optimum prediction mode for the current block. For example, the prediction mode determiner 300 determines the prediction mode having the least difference between an intra predicted block and the current block as the optimum prediction mode. In other words, when the prediction mode determiner 300 determines the optimum prediction mode by encoding the current block in a total of 15 modes from the 4×4 intra prediction modes, 16×16 intra prediction modes, the row mode and the column mode, the optimum prediction mode has the least prediction error and distortion between the current block and a block predicted by the predictor 310.

The encoder 320 encodes the pixels in the first pixel group using the pixel values in the first pixel group predicted in the optimum prediction mode determined by the prediction mode determiner 300. In detail, the encoder 320 calculates prediction errors by subtracting the pixel values predicted by the predictor 310 from actual pixel values in the first pixel group, and quantizes the calculated prediction errors by transforming the prediction errors to the frequency domain.

The reconstructor 330 inverse quantizes the quantized prediction errors in the first pixel group and then inverse transforms the prediction errors in order to provide reconstructed pixel values of the first pixel group used in encoding the pixels in the first pixel group to the predictor 310.

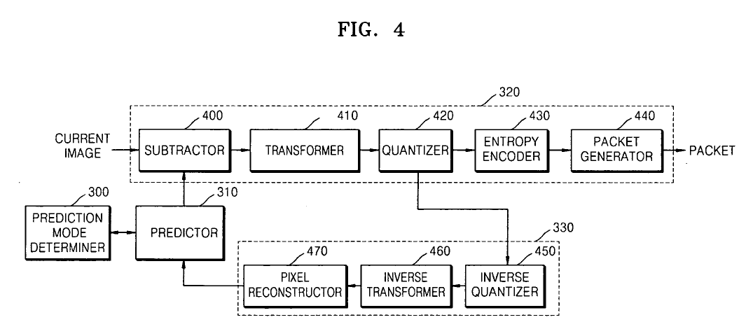

FIG. 4 is a block diagram of the encoder 320 and the reconstructor 330 illustrated in FIG. 3 according to an embodiment of the present invention. Referring to FIG. 4, the encoder 320 includes a subtractor 400, a transformer 410, a quantizer 420, an entropy encoder 430, and a packet generator 440. The reconstructor 330 includes an inverse quantizer 450, an inverse transformer 460, and a pixel reconstructor 470.

When the pixel values of the first pixel group are predicted using the pixel values of the second pixel group, the subtractor 400 calculates prediction errors by subtracting the predicted pixel values from the actual pixel values of the first pixel group. A differential pulse code modulation (DPCM) may be used in order to calculate the prediction errors. For example, when the prediction mode is the row mode, the prediction errors illustrated in FIG. 5C are values obtained by respectively subtracting the predicted pixel values of the first row from the actual pixel values of the first row. When the prediction mode is the column mode, the prediction errors illustrated in FIG. 5D are values obtained by respectively subtracting the predicted pixel values of the first column from the actual pixel values of the first column.

The transformer 410 transforms the prediction errors calculated by the subtractor 400 to the frequency domain. In other words, the transformer 410 transforms the prediction errors in a pixel domain to the prediction errors in the frequency domain by performing a one-dimensional discrete cosine transform (DCT) on the prediction errors. Conventionally, a two-dimensional DCT was used but in the current embodiment, the one-dimensional DCT can be used, and thus the prediction errors can be transformed quickly and simply. The one-dimensional DCT can be defined as Equation 1 below.

$$Y = C \cdot X ⊗ E = ( [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] [ X ] ) ⊗ [ \begin{matrix}a \\ b / 2 \\ a \\ b / 2\end{matrix} ] \qquad ( 1 )$$

Here, Y is a prediction error in the frequency domain, X is a prediction error in the pixel domain, C is a DCT matrix, and E is a scaling factor.

The quantizer 420 quantizes the prediction errors transformed to a frequency domain by the transformer 410. That is, the prediction errors in the frequency domain are divided into a quantization parameter and the results are approximated to integers. The quantization can be performed using Equation 2 below.

$$Z = W \cdot \frac{PF}{Q Step} = W \cdot \frac{MF}{{2}^{qbits}} = ( W \cdot MF + ) >> qbits \qquad ( 2 )$$

Here, Z is a quantized coefficient, W is an unscaled coefficient, that is W=C·X, QStep is a quantization step size, and PF is a or b/2 according to the position of a pixel.

The entropy encoder 430 generates a bit stream by entropy encoding the quantized prediction errors. In H.264/AVC, context-adaptive variable length coding (CAVLC), context-adaptive binary arithmetic coding (CABAC), or the like is used as an entropy encoding method.

The packet generator 440 generates a packet including information about the prediction mode determined by the prediction mode determiner 300 and the bit stream generated by the entropy encoder 430, and provides the packet to an apparatus for decoding an image.

The inverse quantizer 450 inverse quantizes the prediction errors quantized by the quantizer 420. In other words, the inverse quantizer 450 inverse quantizes the prediction errors in the frequency domain by multiplying the quantization parameter to integers approximated by the quantizer 420.

The inverse transformer 460 reconstructs the prediction errors to the pixel domain by performing a one-dimensional inverse DCT on the inverse quantized prediction errors in the frequency domain.

Here, the one-dimensional inverse DCT can be performed using Equation 3 below.

$${X}^{′} C \cdot ( Y ⊗ E ) = [ \begin{matrix}1 & 1 & 1 & 1 / 2 \\ 1 & 1 / 2 & - 1 & - 1 \\ 1 & - 1 / 2 & - 1 & 1 \\ 1 & - 1 & 1 & - 1 / 2\end{matrix} ] ( [ Y ⊗ [ \begin{matrix}a \\ b \\ a \\ b\end{matrix} ] ] ) \qquad ( 3 )$$

The pixel reconstructor 470 generates reconstructed pixels by adding the predicted pixel values output from the predictor 310 to the prediction errors in a pixel domain output from the inverse transformer 460.

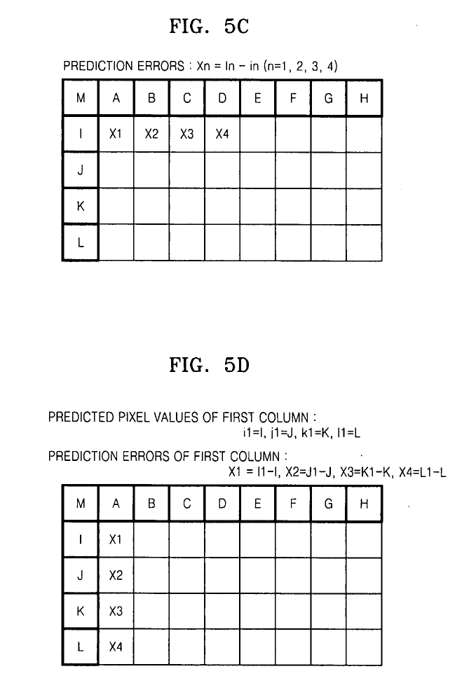

FIG. 6 is a flowchart of a method of encoding an image according to an embodiment of the present invention.

Referring to FIG. 6, an apparatus for encoding an image predicts pixels in a current block using pixel values in the current block, in operation S600.

The process of predicting the current block using the pixel values of the current block will now be described in detail. When a current image is formed of a plurality of blocks and one block is formed of a plurality of pixel groups, the apparatus performs intra prediction in each pixel group by predicting pixel values in a first pixel group using pixel values in a second pixel group, in operation S600.

When the prediction mode is the row mode, the first pixel group is formed of pixels in a first row and the second pixel group is formed of A, B, C, and D, which are pixels in the row above the first row, as illustrated in FIGS. 5A and 5B. In this case, in operation S600, the apparatus predicts the pixels in the first row respectively as A, B, C, and D, which are the pixels in the row above the first row.

When the prediction mode is the column mode, the first pixel group is formed of pixels in a first column and the second pixel group is formed of I, J, K, and L, which are pixels in the column to the left of the first column, as illustrated in FIG. 5D. In this case, in operation S600, the apparatus predicts the pixels in the first column respectively as I, J, K, and L, which are the pixels in the column to the left of the first column.

However, in the case of the row mode, when the first row is the top row of the current block, the pixel values of the first row are predicted using pixel values in the lowest row of the block above the current block. In the case of the column mode, when the first column is the leftmost column of the current block, the pixel values in the first column are predicted using pixel values in the rightmost column of the block to the left of the current block.

In operation S610, the apparatus encodes the pixels in the first pixel group using the pixel values of the first pixel group predicted in operation S600. In detail, prediction errors of the pixels in the first group are calculated, and the calculated prediction errors are quantized by transforming the prediction errors to a frequency domain. Here, the prediction errors are obtained by subtracting the pixel values predicted in operation S600 from the actual pixel values of the first pixel group.

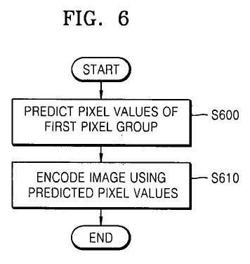

FIG. 7 is a flowchart illustrating a method of encoding an image according to another embodiment of the present invention.

Referring to FIG. 7, an apparatus for encoding an image predicts pixel values in a current block by searching a current picture in operation S700. The apparatus according to an embodiment of the present invention performs intra prediction not only in the 16×16 intra prediction modes and 4×4 intra prediction modes illustrated in FIGS. 1 and 2, but also using the pixel values in the current block.

The process of predicting the pixels in the current block using the pixel values of the current block will now be described in detail. When a current image is formed of a plurality of blocks and one block is formed of a plurality of pixel groups, the apparatus performs intra prediction in each pixel group by predicting pixel values of a first pixel group, using pixel values of a second pixel group.

When the prediction mode is the row mode, the first pixel group is formed of pixels in a first row and the second pixel group is formed of A, B, C, and D, which are pixels in the row above the first row, as illustrated in FIGS. 5A and 5B. In this case, the apparatus predicts the pixels in the first row respectively as A, B, C, and D, which are the pixels in the row above the first row, in operation S700.

When the prediction mode is the column mode, the first pixel group is formed of pixels in a first column and the second pixel group is formed of I, J, K, and L, which are pixels in the column to the left of the first column, as illustrated in FIG. 5D. In this case, the apparatus predicts the pixels in the first column respectively as I, J. K, and L, which are the pixels in the column to the left of the first column in operation S700.

However, in the case of the row mode, when the first row is the top row of the current block, the pixel values of the first row are predicted using pixel values of the lowest row of the block above the current block. Also, in the case of the column mode, when the first column is the leftmost column of the current block, the pixel values of the first column are predicted using pixel values of the rightmost column of the block to the left of the current block.

The apparatus determines the optimum prediction mode for the current block in operation S710. For example, the apparatus determines a prediction mode which has the minimum difference between an intra predicted block and the current block as the optimum prediction mode. In other words, when the apparatus determines the optimum prediction mode by encoding the current block in total 15 modes from the 4×4 intra prediction modes, 16×16 intra prediction modes, the row mode and the column mode, the optimum prediction mode has the least prediction error and distortion between the current block and the intra predicted block.

The apparatus calculates prediction errors of the pixels in the first pixel group by subtracting the predicted pixel values of the first pixel group predicted in the optimum prediction mode determined in operation S710 from the actual pixel values of the first pixel group in operation S720. The prediction errors may be calculated using a DPCM.

The apparatus transforms the prediction errors calculated in operation S720 to the frequency domain in operation S730. Here, a one-dimensional DCT is performed to transform the prediction errors from the pixel domain to the frequency domain. Conventional prediction modes use a two-dimensional DCT, whereas the row mode and the column mode according to the current embodiment use the one-dimensional DCT. Accordingly, the prediction errors can be transformed quickly and simply. Here, the one-dimensional DCT can be expressed as Equation 1 above.

In operation S740, the apparatus quantizes the prediction errors transformed in operation S730. That is, the prediction errors transformed to a frequency domain are divided into a quantization parameter, and the results are approximated to integers. Here, the quantization can be expressed as Equation 2 above.

In operation S750, the apparatus generates a bit stream by entropy encoding the prediction errors quantized in operation S740. In H.264/AVC, CAVLC, CABAC, or the like is used as an entropy encoding method.

In operation S760, the apparatus generates a packet including information about the prediction mode determined in operation S710 and the bit stream generated in operation S750, and provides the packet to an apparatus for decoding an image.

In operation S770, the apparatus generates reconstructed pixels using the prediction errors quantized in operation S740. Reconstructing of the pixels is performed by inverse quantizing the prediction errors quantized in operation S740 and inverse transforming the inverse quantized prediction errors to the pixel domain by performing a one-dimensional inverse DCT. Here, the one-dimensional inverse DCT can be expressed as Equation 3. Also, the reconstructed pixel values are generated by adding the inverse transformed prediction errors to the pixel values of the first pixel group predicted in operation S700.

In operation S780, it is determined whether the current block has been encoded. When the encoding is not complete, operation S720 is performed in order to calculate prediction errors of the next pixel group.

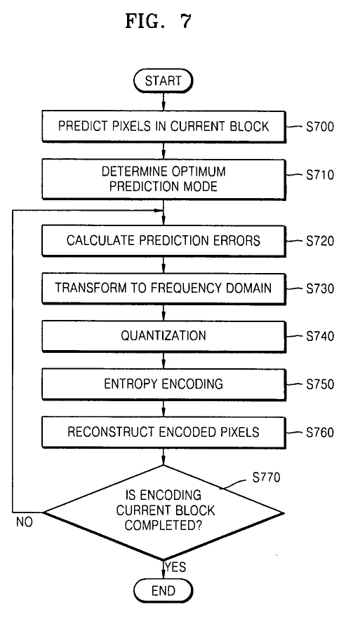

FIG. 8 is a graph of peak signal to noise ratios (PSNRs) of a conventional 4×4 intra prediction mode and a conventional intra prediction mode with a row mode and a column mode which are used instead of the 5^{th} and 7^{th} modes of the conventional intra prediction mode.

Referring to FIG. 8, the PSNRs of the row mode and the column mode of the present invention are higher than the PSNR of the conventional intra prediction modes, and thus an image having an improved quality can be provided to a user.

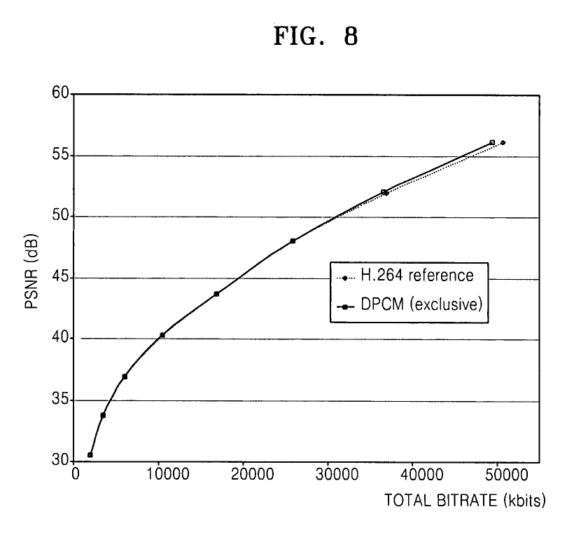

FIG. 9 is a graph of PSNR of various methods of encoding an image in an intra prediction mode according to the present invention and a conventional 16×16 intra prediction mode. Referring to FIG. 9, the PSNR of the intra prediction mode according to the present invention is higher than the PSNR (Ref in FIG. 9) of the conventional intra prediction mode.

Here, 12ACctx denotes 12AC context, when a discrete hadamard transform (DHT) is performed on a DC component block generated via a DCT, and 12 AC contexts are used in CABAC for entropy coding. LongScanA is when DHT is not performed on the DC component block generated via a DCT, and 4 AC contexts are used in the CABAC. LongScanADPCM2 is when the DHT is performed on a DC component block generated via a DCT.

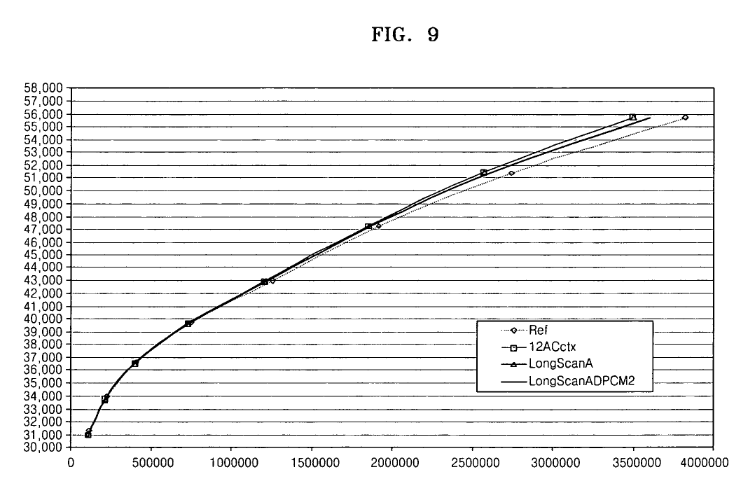

FIG. 10 is a block diagram of an apparatus for decoding an image according to an embodiment of the present invention. Referring to FIG. 10, the apparatus includes a predictor 1010 and a decoder 1020.

The predictor 1010 predicts pixels in a current block by using the same prediction mode as used in the apparatus for encoding the image. When a prediction mode according to the present invention is used, the predictor 1010 predicts the pixels using pixel values of the current block.

The process of predicting the pixels using the pixel values of the current block will now be described in detail. When a current image is formed of a plurality of blocks, and one block is formed of a plurality of pixel groups, the predictor 1010 performs intra prediction in each pixel group by predicting pixel values of a first pixel group using pixel values of a second pixel group.

When the prediction mode is the row mode, the first pixel group is formed of pixels in a first row, and the second pixel group is formed A, B, C, and D, which are pixels in the row above the first row, as illustrated in FIGS. 5A and 5B. In this case, the predictor 1010 predicts the pixels in the first row respectively as A, B, C, and D, which are the pixels in the row above the first row.

When the prediction mode is the column mode, the first pixel group is formed of pixels in a first column and the second pixel group is formed of I, J, K, and L, which are pixels in the column to the left of the first column, as illustrated in FIG. 5D. In this case, the predictor 1010 predicts the pixels in the first column respectively as I, J, K, and L, which are the pixels in the column to the left of the first column.

The decoder 1020 decodes the pixels in the first pixel group using a bit stream provided by the apparatus for encoding an image and the pixel values of the first pixel group predicted by the predictor 1010. Reconstructed prediction errors are calculated by entropy decoding, inverse quantizing, and inverse transforming the bit stream of the pixels in the first pixel group, and the pixels in the first pixel group are decoded by adding the reconstructed prediction errors to the pixel values of the first pixel group predicted by the predictor 1010.

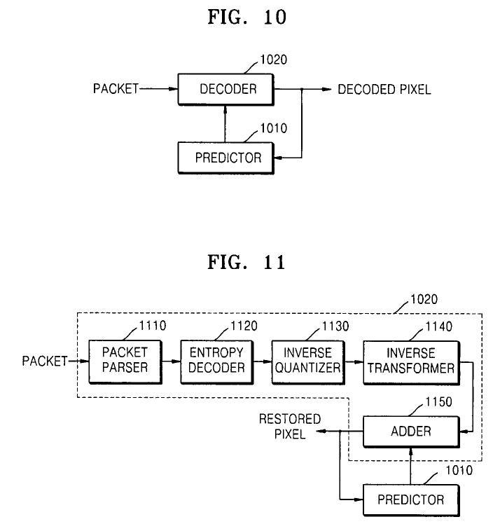

FIG. 11 is a block diagram of a decoder 1020 according to an embodiment of the present invention. Referring to FIG. 11, the decoder 1020 includes a packet parser 1110, an entropy decoder 1120, an inverse quantizer 1130, an inverse transformer 1140, and an adder 1150.

The packet parser 1110 extracts information about a prediction mode used in predicting a current block and a bit stream by parsing a packet transmitted from an apparatus for encoding an image.

The entropy decoder 1120 generates a quantized coefficient by entropy decoding the bit stream extracted by the packet parser 1110. The inverse quantizer 1130 and the inverse transformer 1140 reconstruct prediction errors by inverse quantizing and inverse transforming the quantized coefficient.

The adder 1150 decodes pixels in a first pixel group by adding the prediction errors reconstructed by the inverse transformer 1140 to pixel values of the first pixel group predicted by the predictor 1010.

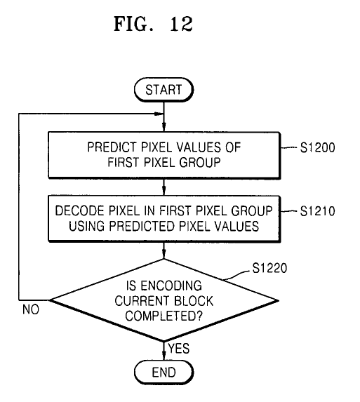

FIG. 12 is a flowchart illustrating a method of decoding an image according to an embodiment of the present invention.

Referring to FIG. 12, an apparatus for decoding an image predicts pixels in a current block using the same prediction mode as used in the apparatus for encoding the image in operation S1200. When a prediction mode according to the present invention is used, the pixels are predicted using pixel values of the current block.

The process of predicting the pixels using the pixel values of the current block will now be described in detail. When a current image is formed of a plurality of blocks and one block is formed of a plurality of pixel groups, the apparatus for decoding an image performs intra prediction in each pixel group by intra predicting pixel values of a first pixel group using pixel values in a second pixel group in operation S1200.

When the prediction mode is the row mode, the first pixel group is formed of pixels in a first row and the second pixel group is formed of A, B, C, and D, which are pixels in the row above the first row, as illustrated in FIGS. 5A and 5B. In this case, the apparatus for decoding an image predicts the pixels in the first row respectively as A, B, C, and D, which are the pixels in the row above the first row in operation S1200.

When the prediction mode is the column mode, the first pixel group is formed of pixels in a first column and the second pixel group is formed of I, J, K, and L, which are pixels in the column to the left of the first column, as illustrated in FIG. 5D. In this case, the apparatus for decoding an image predicts the pixels in the first column respectively as I, J, K, and L, which are the pixels in the column to the left of the first column in operation S120.

In operation S1210, the apparatus for decoding an image decodes the pixels in the first pixel group using a bit stream provided from the apparatus for encoding an image and the pixel values of the first pixel group predicted in operation S1200. In detail, reconstructed prediction errors are calculated by entropy decoding, inverse quantizing, and inverse transforming a bit stream of the pixels in the first pixel group, and decodes the pixels in the first pixel group by adding the reconstructed prediction errors to the pixel values of the first pixel group predicted in operation S1200.

In operation S1220, it is determined whether decoding the current block is completed, and when the decoding is not complete, operation S1210 is performed in order to predict pixels in the next pixel group.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The present invention may be embodied in a computer readable medium having a computer readable program code unit embodied therein for causing a number of computer systems connected via a network to effect distributed processing.

As described above, according to the method and apparatus for encoding an image according to the present invention, the value of a first pixel in a block of a current image is predicted using the value of a second pixel in the same block, and the current block is encoded using the predicted value. Accordingly, intra prediction is performed using an adjacent pixel in the same block, and thus the prediction efficiency and compression rate of encoding image data are increased.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of encoding an image, comprising:
predicting pixel values in a first pixel group from among pixel groups of a block of a current image, using pixel values in a second pixel group of the block; and
encoding the current image using the predicted pixel values.

2. The method of claim 1, wherein the pixel groups are rows of the block, and in the predicting of the pixel values, the pixel values in a first row of the block are predicted using pixel values in a second row of the block.

3. The method of claim 1, wherein the pixel groups are columns of the block, and in the predicting of the pixel values, the pixel values in a first column of the block are predicted using pixel values in a second column of the block.

4. The method of claim 2, wherein when the first row is the top row of the block, the pixel values of the first row are predicted using pixel values in the bottom row of the block above the first row.

5. The method of claim 3, wherein when the first column is the leftmost column of the block, the pixel values in the first column are predicted using pixel values in the rightmost column of the block to the left of the first column.

6. The method of claim 1, further comprising determining a prediction mode which minimizes the difference between the predicted pixel values in the block and actual pixel values in the block.

7. The method of claim 1, further comprising reconstructing the pixel values in the first pixel group, wherein in the predicting of the pixel values, the pixel values in the first pixel group are predicted using the reconstructed pixel values.

8. The method of claim 7, wherein the encoding of the current image comprises:
calculating prediction errors by subtracting the predicted pixel values from the actual pixel values;
transforming the calculated prediction errors to a frequency domain; and
quantizing the prediction errors transformed to the frequency domain.

9. The method of claim 8, wherein the reconstructing of the pixel values comprises:
inverse quantizing the quantized prediction errors;
inverse transforming the inverse quantized prediction errors from the frequency domain to a pixel domain by performing a one-dimensional inverse discrete cosine transform (DCT); and
reconstructing the pixel values in the first pixel group by adding the inverse transformed prediction errors to the predicted pixel values in the first pixel group.

10. An apparatus for encoding an image, comprising:
a predictor which predicts pixel values in a first pixel group from among pixel groups of a block of a current image, using pixel values in a second pixel group of the block; and
an encoder which encodes the current image using the predicted pixel values.

11. A method of decoding an image, comprising:
predicting pixel values in a first pixel group from among pixel values of a block of a current image, using pixel values in a second pixel group of the block; and
decoding the current image using the predicted pixel values.

12. The method of claim 11, wherein the pixel groups are rows of the block, and in the predicting of the pixel values, the pixel values of a first row of the block are predicted using pixel values in a second row of the block.

13. The method of claim 11, wherein the pixel groups are columns, and in the predicting of the pixel values, the pixel values of a first column of the block are predicted using pixel values in a second column of the block.

14. The method of claim 12, wherein when the first row is the top row of the block, the pixel values in the first row are predicted using pixel values in the bottom row of the block above the first row.

15. The method of claim 13, wherein when the first column is the leftmost column of the block, the pixel values in the first column are predicted using pixel values in the rightmost column of the block to the left of the first column.

16. The method of claim 11, further comprising determining a prediction mode which is to be used in decoding the block, referring to a prediction mode used in encoding the block.

17. An apparatus for decoding an image, comprising:
a predictor which predicts pixel values in a first pixel group from among pixel groups of a block of a received image, using pixel values in a second group of the block; and
a decoder which decodes the received image using the predicted pixel values.

18. A computer readable recording medium having recorded thereon a program for executing the method of any one of claims 1.

19. A computer readable recording medium having recorded thereon a program for executing the method of any one of claims 11.
